(19) United States
(12) Patent Application Publication
(10) Pub. No.: US 2026/0141294 A1
(43) Pub. Date: May 21, 2026

(54) Learning to Rank with Ordinal Regression

(71) Applicant: Google LLC, Mountain View, CA (US)

(72) Inventor: Gil Shamir, Sewickley, PA (US)

(21) Appl. No.: 19/114,221

(22) PCT Filed: Sep. 21, 2022
(86) PCT No.: PCT/US2022/044225

§ 371 Date: Mar. 21, 2025

(51) Int. Cl. G06N 20/00

(52) U.S. Cl. CPC G06N 20/00

(57) ABSTRACT

Provided are pairwise and listwise ranking losses that can be used to improve ranking relations among co-recommended items for multi-label multi-class logistic regression, where the labels of the classes are ordered in a meaningful way. The proposed ranking losses can be integrated into an ordinal regression framework and reflect ideas that frame ranking losses as losses on conditional probabilities that are conditioned on events in which objects in a co-recommended list have unequal labels. Example implementations of the present disclosure leverage ordinal regression to provide an ordering framework between the multiple class labels and use the conditioning framework over it to apply ranking losses between pairs or within lists of items, such that the multi-label objective predictions are focused on improving ordinal label ranking among co-recommended items. These example implementations can be achieved using losses that push gradients to enhance learning label differences between different items.

### FIELD

The present disclosure relates generally to machine learning. More particularly, the present disclosure relates to pairwise and listwise ranking losses that enable improved ranking relations among co-recommended items for (graded) multi-label multi-class logistic regression, where the labels of the classes are ordered in a meaningful way.

### BACKGROUND

Ranking is an important aspect of various systems or applications such as recommendation systems, information retrieval systems (e.g., search engines), and/or other systems. Ranking can refer to the concept of defining a relative ordering between potential items as responses to a particular query. A query can be implicit (e.g., defined based on context) or explicit (e.g., defined based on specific natural language and/or image input (e.g., input by a user)). A query can be user-agnostic or user-specific. Thus, items that are candidates for providing as a response to the query can be ranked, where, for example, the ranking orders the items from most relevant to less relevant.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to perform training for ranking with ordinal regression on graded multi-valued labeled data. The method includes processing, by a computing system comprising one or more computing devices, a first input with a machine-learned ranking model to generate a first score vector for the first input. The method includes processing, by the computing system comprising one or more computing devices, a second input with the machine-learned ranking model to generate a second score vector for the second input. The method includes determining, by the computing system, a combined score vector for the first input and the second input based on the first score vector and the second score vector, the combined score vector having a plurality of coordinates. The method includes applying, by the computing system, a respective scoring function to each of the plurality of coordinates of the combined score vector to generate a respective label output for each of a plurality of labels. The method includes evaluating, by the computing system, a ranking loss function based on one or more of the respective label outputs generated for the plurality of labels. The method includes modifying, by the computing system, the machine-learned ranking model based on the ranking loss function.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A shows a graphical illustration of softmax multi-label prediction.

FIG. 1B shows a graphical illustration of ordinal regression Cumulative Distribution Function (CDF) prediction.

FIG. 2 shows a graphical illustration of an example application of CDF ordinal regression pairwise ranking loss according to example embodiments of the present disclosure.

FIG. 3 shows a graphical illustration of an example application of CDF ordinal regression listwise ranking loss according to example embodiments of the present disclosure.

FIG. 4A depicts a block diagram of an example computing system according to example embodiments of the present disclosure.

FIG. 4B depicts a block diagram of an example computing device according to example embodiments of the present disclosure.

FIG. 4C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to pairwise and listwise ranking losses that can be used to improve ranking relations among co-recommended items for graded multi-label multi-class logistic regression, where the labels of the classes are ordered in a meaningful way. The proposed ranking losses can be integrated into an ordinal regression framework and reflect ideas that frame ranking losses as losses on conditional probabilities that are conditioned on events in which objects in a co-recommended list have unequal labels. Example implementations of the present disclosure leverage ordinal regression to provide an ordering framework between the multiple class labels and use the conditioning framework over it to apply ranking losses between pairs or within lists of items, such that the multi-label objective predictions are focused on improving ordinal label ranking among co-recommended items. These example implementations can be achieved using losses that push gradients to enhance learning label differences between different items. The proposed techniques can also be extended to a distillation training approach in which an expensive teacher model that is trained on more data is used to provide prediction scores as labels to be used by a relatively simpler student model, to speed the training and improve the ranking accuracy of the student model.

More particularly, ordinal regression, also called ordinal classification, is a type of regression analysis used for predicting an ordinal variable. An ordinal variable is a variable whose value exists on an arbitrary scale where only the relative ordering between different values is significant. Some ordinal regression approaches can be used or viewed as a solution for multi-class classification, where the order of the classes matters. In these settings, a model should still try to classify input(s) to the best class. However, erring towards classes that are nearby is better than erring towards classes that are farther away. This problem roughly falls between regression and classification, where a model still needs to predict a class, but there is some (possibly indeterminable and/or vague) metric that scales costs if the model errs to a class that is farther away from the correct one.

One of the advantages of ordinal regression is exactly in the ability to model highly indeterminable and/or vague scenarios in which there is no clear definition of distance metrics between classes, but there is clearly an order between them. Note that in many problems in which there are clear distance definitions between classes, regressions such as linear regression may suffice. Consider, on the other hand, an example of human rating scores of objects (e.g., for recommendation or other purposes), where humans are asked to give a verbal score (e.g., “excellent” “fair”, “poor”, etc.) or a numerical score. Such ratings may be hard to map into a metric space (even with numerical ratings, given that they may be very subjective). Building a model that relies on some distances based on these ratings will require mapping ratings into such a space. Such mappings, however, may be subjective and may introduce noise into the model. In such ratings, there is no guarantee that a uniform or normal distance mapping reflects the true model.

In contrast, with ordinal regression, models can focus on learning the Probability Mass Function (PMF) of the label distribution, by learning the probability of each label. Unlike multiclass softmax learning, which in some cases may also learn a PMF of labels of multiple classes, using ordinal regression retains the ordering among the labels. Retaining this ordering enables the use of smoothing functions that smear the regions between the labels. For ranking applications such as relevance ranking, this can be desirable, especially with subjective human ranking. To provide an example, if a system is given 10 labels, and 60% of rankers chose labels {8,9} (30% each), but 40% of rankers chose label 1, then a multi-class method will choose label 1. However, an ordinal regression method may actually choose label 8 or 9.

Thus, smoothing losses can actually enhance the bucket of the top labels and clarify the decision. Note though that without these additional steps, the predictions of ordinal regression can in some instances be viewed as just giving the PMF of the label classes similarly to multi-class classification. However, multi-class classification, for example with softmax cross entropy loss logistic regression, does not provide the extended ability to leverage ordering among the classes.

Ordinal regression optimization where there is a predefined finite set of labels can be performed as a method in which a gradual accumulation of the PMF is learned. If labels are ordered in increasing order, ordinal regression can learn the Cumulative Distribution Function (CDF) of the label PMF, where for a particular label, the model learns the probability of the label being the particular label or any of the labels below it. Approaches like these have been adapted to neural networks by prior works. In many of these works, ranking decisions are then made by choosing a point where the CDF crosses some threshold and using that point as a predicted label (or ranking) of an object. Learning the CDF, however, can also be used to transform predictions back to the PMF, by taking the differences between the different CDF points.

Ordinal regression can be used for predicting ranking of items or objects in a list. For example, a model can predict what the ranking of a specific object would be among a set of objects. One related task performed by example implementations of the present disclosure is to use such predictions to select which items/objects to show and in which order (e.g., in the context of providing a list of results in response to a query). For example, example implementations of the present disclosure can predict which items are likely to receive the highest ranking labels, and choose to show these items, where the ones more likely to receive higher labels are shown first in the better positions (e.g., earlier in the list or carousel, higher on a search results page, etc.).

Specifically, example implementations can leverage predictions of ordinal regression to perform the task described above by using the predicted CDF or PMF, and by selecting items with the lowest CDF values for the largest labels. The CDF value of the largest (e.g., highest ranking) label can be equal to 1, but if that of the second largest is smaller than the threshold, the largest label has a nonzero probability, and if the CDF is larger than a threshold at its second highest point, this label can be predicted. Such a method can be applied also for some lower threshold than the second largest label, or by setting an acceptable probability for a set of high value labels and including items whose probabilities of taking any label in this set exceed this acceptance threshold. Alternatively, the expected label can be used, or other statistics.

However, aspects of the present disclosure focus not on how to determine which items to show based on the predicted CDF, but instead on how to generate the CDF prediction such that ranking accuracy of predictions relative to the true labels among items in the same list is maximized. This implies that the prediction for a better label for an object with a better label in a pair of objects will be likely higher than the prediction for the better labels for the item with the worse label (and vice versa for the worse labels).

All of the prior work with ordinal regression is directed to scoring individual objects. Binary logistic regression (or probit regression) models can be applied to learn the CDF at each label, as described above, for each object. However, in systems like recommender systems, items that are co-recommended together affect each other's labels. These effects can be modeled by features included in the model for each of the items. However, models that train on objectives of engagement rates of individual items may still not capture the full interactions because they implicitly marginalize on the individual engagement rates, implicitly assuming independence between the engagement rates of the different items.

Furthermore, such models are always misspecified using hand-crafted features to model real world user response behavior. With misspecification, optimizing for individual rates can lead to different solutions from optimization of the ranking relation between objects. In a recommendation system, where ranking among items is equally if not more important than the prediction of individual engagement rates, it may be beneficial to focus training on ranking among items instead of on learning individual labels of an item. This can be done by using only a loss designed to specifically learn ranking and differences among items, or by using this loss together with the standard engagement rates loss, tuning and balancing between the two.

In view of the above, aspects of the present disclosure extend a conditional view of ranking losses to ordinal regression. Ordinal regression sets a framework that simplifies the introduction of pairwise or listwise ranking loss for graded labels. Example techniques proposed by the present disclosure leverage both ordinal regression on one hand and the conditional view of ranking losses on the other to derive methods that give a model the opportunity to improve its multi-label ranking among items that are shown together, such that items that are chosen to be ranked higher (and show in better positions) are the ones likely to have higher engagement labels, when items are compared to one another. Like ranking losses for a binary case, one objective here is to improve the accuracy of ranking prediction within a set of items shown together when predictions are measured relative to the true labels. This should be done with minimal effect to prediction accuracy of individual engagement labels, but leveraging the misspecification and non-independence of labels of different items towards improving prediction of label ranking.

Thus, example aspects of the present disclosure introduce a ranking loss that can be applied with ordinal regression. This loss can be applied in a pairwise setting, but unlike a multi-label softmax case, the proposed losses can also be applied in a listwise setting reducing the complexity in the number of items shown together in a set of items. An additional advantage over softmax multi-label ranking loss is that if a system updates a pairwise ranking loss between two items that had two different labels (e.g., m and k), the loss will not affect probabilities predicted for any labels outside the range between m and k for either item. Using a softmax loss that only affects logits in the range between m and k could still affect the predicted probabilities of labels outside the range (but not their logits).

First, example optimizations for ordinal regression are provided. Pairwise and then listwise ranking losses are then introduced that can be applied in this framework. Next, ranking based on ordinal predictions is described. Finally, an additional section demonstrates how distillation can be applied to ordinal regression both to the “direct” pointwise label loss, and for the ranking losses (pairwise and listwise).

### An Example CDF Interpretation of Ordinal Regression

Consider a machine learning model that trains over sets of examples. Each set of examples can include a number of items (e.g., objects, products, entities, webpages, files, and/or any other discrete item that might be returned or suggested in an information retrieval and/or recommendation context). Each set was previously produced in the system. For example, if it is a recommendation system, each set can include a list of recommendations that were shown to a user. Each example in the set can have a label that was given to it by the user's engagement, rating, and/or by its relevance to the task for which it was recommended.

Without loss of generality, a label can take one of L values {0, 1, . . . , L−1}, where label values are ordered by relevance or ranking. A 0 label gives the lowest ranking or relevance. A label of value L−1 is the highest ranking or highest engagement. If labels model user engagement, then a 0 label can mean no engagement at all, and an L−1 label means the maximum engagement. Alternatively, if labels are human ratings, a 0 label means the worst rating for the task at hand, and an L−1 label means the highest ranking.

Each set of items can have N_t items, where t is the index of the set, each of the N_t items has a label from the set of the L possible labels. For convenience and brevity, the remainder of this description will describe the method for some set t, and omit the subscript t. Typically, the full loss will aggregate over all example sets from t=1 to t=T, for some total size of T example sets.

Thus, a given input may have a ground truth label value associated therewith within a set of training data. The ground truth label value for a particular item i within a particular set may be represented as y_i. More particularly, let i∈{1, 2, . . . , N} be the index of the i-th item in the set of examples. Then, y_i∈{0, 1, . . . , L−1}. A training algorithm produces a score vector sᵢ for the i-th item in the set.

In an example CDF implementation of ordinal regression, the score vector sᵢ can include L−1 values, [symbol] ∈{0, 1, . . . , L−2}, which are, for example, binary logit values of the points of the CDF believed for the labels of example i given by

$${s}_{i ℓ} {=}^{△} log \frac{Pr ( {y}_{i} \leq ℓ )}{Pr ( {y}_{i} > ℓ )} = log \frac{Pr ( {y}_{i} \leq ℓ )}{1 - Pr ( {y}_{i} \leq ℓ )} . \qquad ( 1 )$$

$$We can define$$

$${p}_{i ℓ} {=}^{△} Pr ( {y}_{i} \leq ℓ ) . \qquad ( 2 )$$

Thus, the model trains L−1 binary logistic regression losses over the examples, where the [symbol] -th one matches the objective of the CDF at label [symbol] . Thus the CDF label value for the [symbol] -th model is in {0, 1}, taking value 1 if yᵢ≤ [symbol] , and value 0, otherwise. For example, if L=10, and yᵢ=6, then, we train 9 logistic regression losses where the labels are {0, 0, 0, 0, 0, 0, 1, 1, 1}. As another example, for yᵢ=3, the labels are {0, 0, 0, 1, 1, 1, 1, 1, 1}.

Thus, for a given ground truth label value (e.g., yᵢ=3), there is a corresponding set of CDF label values for corresponding CDF labels (e.g., the CDF label values for yᵢ=3 and L=10 are {0, 0, 0, 1, 1, 1, 1, 1, 1}). Sometimes, it will be more convenient to reverse the roles of 0 and 1.

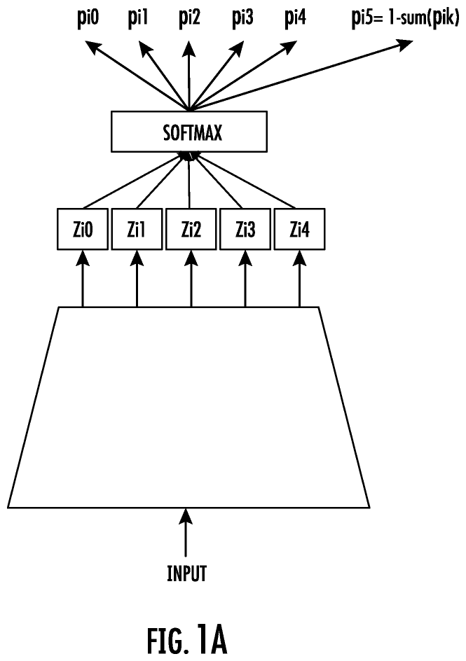

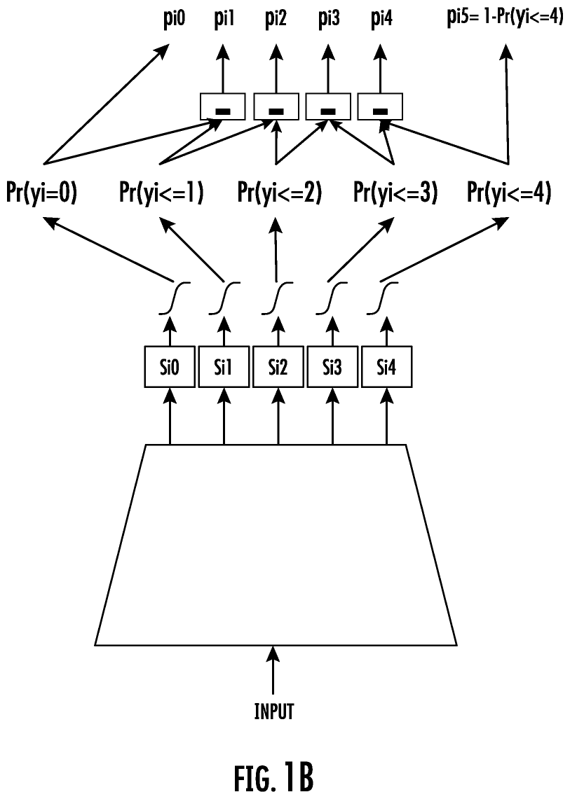

As examples, FIGS. 1A and 1B illustrate differences between softmax multi-label prediction (FIG. 1A) and ordinal regression CDF prediction (FIG. 1B) in an example setting in which L=6.

In particular, in either of the approaches shown in FIGS. 1A and 1B, a neural network can generate L−1 outputs, where all input feature vectors feed into the network. The L−1 outputs can be fully connected to some penultimate hidden layer.

However, in the ordinal regression prediction shown in FIG. 1B, for each of the L−1 outputs, a different label loss can be applied taking the labels from the vector of CDF labels as described above. Therefore, in some instances, the structure of the network is identical to that of a network with a Softmax loss (e.g., shown in FIG. 1A). However, one difference is that instead of applying a single softmax cross entropy loss on all L (or L−1) outputs as shown in FIG. 1A, instead, in FIG. 1B, each of the L−1 outputs has its own binary logistic regression loss. The loss applied to the [symbol] -th output may simply be:

$${L}_{i ℓ} = - I ( {y}_{i} \leq ℓ ) log {p}_{i ℓ} - I ( {y}_{i} > ℓ ) log ( 1 - {p}_{i ℓ} ) \qquad ( 3 )$$

where I(.) is the indicator function. For each [symbol] , the loss can be aggregated (e.g., summed) over all N items in the set and over all T example sets. The PMF learned for label [symbol] is the difference between its CDF and that of [symbol] −1,

$$Pr ( {y}_{i} - ℓ ) = {p}_{i ℓ} - {p}_{i ; ℓ - 1} \qquad ( 4 )$$

$$where$$

$${p}_{i ; - 1} = 0 , and {p}_{i ; L - 1} = 1 .$$

Note that this formulation of the loss does not guarantee that the learned probability of each label is positive. Additional constraints or regularization capping movements of logit scores can be applied to guarantee nonnegative label probabilities. Some examples of methods that can guarantee nonnegative probabilities in training include learning displacement values from one CDF point to the other (i.e., the probabilities of equation (4)), and constraining them to be nonnegative. Such constraints can be applied in multiple different ways. One would be to learn a latent value v for the displacement, and apply nonnegative range monotone functions, such as ReLU and Softplus, on v to generate the displacement. Another method is to impose Lagrange constraints forcing the learned displacement to be not smaller than 0. Alternatively, this can be ignored in training, but probabilities computed in equation (4) could be clipped at 0 from below when necessary. An implicit negative probability may not be a problem if prediction decisions are made by directly applying threshold on the predicted CDFs.

Example Approaches for Pairwise Ranking with Ordinal Regression

(Conditional) pairwise ranking for binary labels learns logit score differences between items with unequal labels in a set of items. This notion can be extended to multi-labels, by designing losses that update softmax scores of both items for the different labels and for labels within the range between these labels. The “binarization” of the problem with ordinal regression, gives a rather easy binary interpretation for which label losses should be affected by unequal labels. Specifically, in some implementations, the ranking loss function is applied only to labels for which the respective CDF label values for input are unequal.

In particular, assume that a first items (item i) and a second item (item j) in the set of N items have ground truth label values as follows: yᵢ=6 and yⱼ=3, with L=10. Then, the CDF label values are

$${y}_{i}^{l} = \{ 0 , 0 , 0 , 0 , 0 , 0 , 1 , 1 , 1 \} and {y}_{j}^{l} = \{ 0 , 0 , 0 , 1 , 1 , 1 , 1 , 1 , 1 \} .$$

Using the conditional interpretation, where loss is applied only when CDF labels are unequal, gives a loss that should only be applied on the middle 3 CDF label values, as these are the binary cases in which the CDF labels of yᵢ and yⱼ are different. For the first 3 and the last 3 CDF label values, the binary labels are equal. Thus, in some implementations, ranking losses are only applied for [symbol] ∈{3, 4, 5}. More generally, let yᵢ=k and yⱼ=m<k, then the applied ranking losses are

$${L}_{ij , ℓ}^{ℛ} = I ( {y}_{i} > ℓ \geq {y}_{j} ) log \{ 1 + exp [ - ( {s}_{j ℓ} - {s}_{i ℓ} ) ] \} \qquad ( 5 )$$

where I(.) is the indicator function, which is nonzero only in the range between the true labels.

This means that the loss is only applied for the binary learners for label CDFs between m and k in [m, k). The loss itself can be the negative logarithm of the conditional probability that the label of item j is smaller or equal l while that of item i is larger than l conditioned on the event that one of them is larger and the other is smaller than l. Note that the loss with respect to the logit scores is in reverse to the normal pairwise ranking loss because the item with the lower label has positive labels earlier than the item with the larger label because we are using the CDF and not a reverse order.

The collection of losses in equation (5) leads to the expected gradient behavior. Because item i has a larger ground truth label value (6) than item j, which has a ground truth label value of 3, the gradients on the collections of ranking losses applied will push down the logits of item i on labels (3, 4, 5), and up the logits of item j on these labels. This will decrease the CDF of i for these labels and increase the CDF of j for the same labels. The CDFs of other labels for both items remain unchanged. Therefore, the probability of item i taking label 3 will decrease, and the probability of it taking label 6 will increase, because the CDF value of 5 decreased, but that of 6 remained the same. The predicted probabilities for labels 4 and 5 may increase or decrease depending on whether the net change of the CDF of 3, 4 and 5 will push them down or pull them up. For item j, because the CDF for 3 goes up, and that for 2 remains the same, the probability for label 3 will increase. Similarly, because the CDF for 5 goes up, but that for 6 remains the same, the probability predicted for label 6 will decrease.

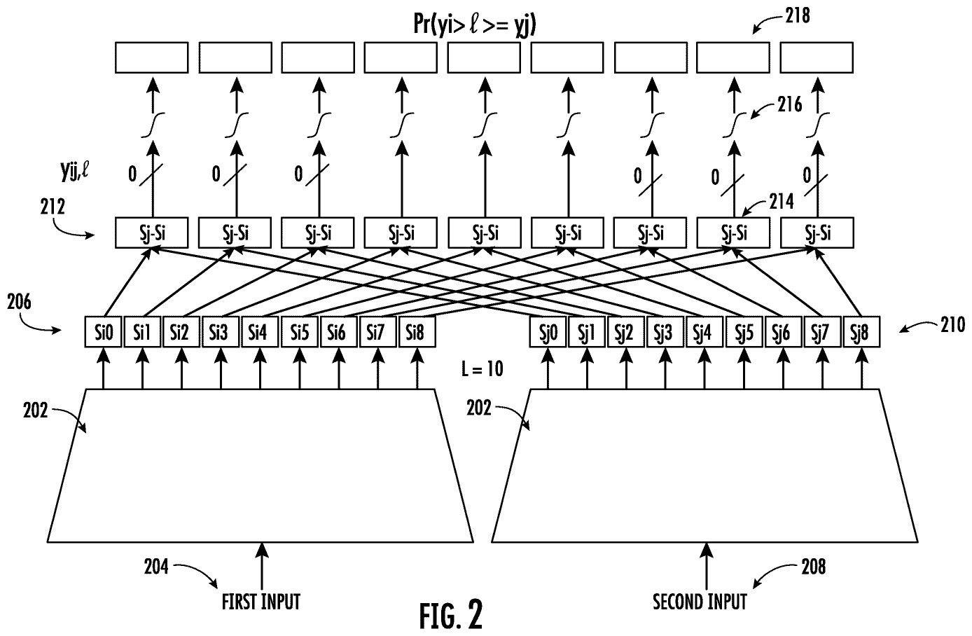

FIG. 2 depicts a graphical diagram of an example application of the CDF ordinal regression pairwise ranking loss for the example described above (yᵢ=6 and yⱼ=3). In particular, as illustrated in FIG. 2, a first input (i) 204 can be processed by a machine-learned ranking model 202 to generate a first score vector 206 for the first input 204. Similarly, a second input (j) 208 can be processed by the machine-learned ranking model 202 to generate a second score vector 210 for the second input 208. A computing system can determine a combined score vector 212 for the first input 204 and the second input 208 based on the first score vector 206 and the second score vector 210. As one example, as illustrated in FIG. 2, the combined score vector 212 can be a difference vector between the first score vector 206 and the second score vector 210. In another example which is described further below; the combined score vector 212 can be a signed label-weighted sum of the first score vector 206 and the second score vector 210.

The combined score vector 212 can include a plurality of coordinates (e.g., coordinate 214). The computing system can apply a respective scoring function to each of the plurality of coordinates of the combined score vector 212 to generate a respective label output for each of a plurality of labels. For example, scoring function 216 can be applied to coordinate 214 to generate a label output 218 (e.g., for [symbol] =7). As one example, as illustrated in FIG. 1, the scoring functions can be logistic functions (e.g., sigmoid functions). In other implementations, various other non-linear functions or other activation functions can be used.

In some implementations, the label output for each label can indicate a respective (predicted) probability that the first input 204 has a first ground truth label value that is greater than the label while the second input 208 has a second ground truth label value that is less than or equal to the label. For example, label output 218 can indicate a predicted probability (ŷ_{ij,7}) that both yᵢ is greater than 7 and yⱼ is less than or equal to 7.

The computing system can evaluate a ranking loss function based on one or more of the respective label outputs generated for the plurality of labels and can modify the machine-learned ranking model 202 based on the ranking loss function. For example, the ranking loss function can compare the label output (e.g., [symbol] ) to a ground truth value (e.g., [symbol] ) for the label.

Thus, probabilities are predicted in forward pass for all label values. However, in some implementations, backward pass only occurs when [symbol] =1, and is stopped when [symbol] =0. For example, where [symbol] indicates for a particular label [symbol] whether the first input 204 has a first ground truth label value that is greater than the label while the second input 208 has a second ground truth label value that is less than or equal to the label. Stated differently, in some implementations, the ranking loss function is applied only when a first ground truth label value for the first input 204 is unequal to a second ground truth label value for the second input 208.

In some implementations, it may be beneficial to weight the loss of each CDF point differently, where some ordinal CDF points are more critical than others.

In some implementations, the pairwise loss is accumulated for every [symbol] . It is applied for every pair i, j∈{1, 2, . . . , N} that satisfies the conditions for each [symbol] , and is aggregated over all example sets. In an example deep network implementation, the [symbol] -th output for item i can be connected with that of item j, and the loss can be applied if [symbol] is in [yⱼ, yᵢ)=[m, k). Otherwise, the labels for the [symbol] -th loss are considered equal, and no loss is applied.

As with the direct ordinal regression loss, there may be situations where the ranking loss (e.g., whether applied by itself or together with a direct loss) may lead to negative predicted label probabilities. This can especially be worsened by applying the loss only partially on CDF label values, i.e., only on those that have unequal CDF labels (for example, in FIG. 2 only on the middle 3 labels, and not on the other 6). It can, for example, consistently increase the CDF value of some label value for some example relative to examples it is paired with, causing it to become greater than the CDF value of the next larger label. Another version of the loss described below can reduce this effect. This can also be handled in the same manner as discussed earlier.

In particular, some example implementations can apply a more general “relation” loss that will consider either equal values of the pairwise labels, or equal values of CDF points but only when the L-ary labels are unequal. If applied for all label pairs, such a loss can be considered a data processing on the direct ordinal regression loss that may improve relations of predictions between items, but is likely to be inferior to the ranking loss for producing more accurate ranking predictions when evalusated relative to the true labels. Let

$${z}_{i}^{l} and {z}_{j}^{l}$$

be mappings of the label vectors

$${y}_{i}^{l} and {y}_{j}^{l}$$

such that 0's are mapped to −1. Thus, {0, 0, 0, 1, 1, 1, 1, 1, 1} is mapped to {−1,−1,−1, 1, 1, 1, 1, 1, 1}. Define the score [symbol] as

$${s}_{ij , ℓ} = {z}_{i ℓ} \cdot {s}_{i ℓ} + {z}_{j ℓ} \cdot {s}_{j ℓ} \qquad ( 6 )$$

i.e., the signed label weighted sum of logit scores of both items. Then, a more general loss that combines the case where labels are equal and the case in which they are not is given by:

$${L}_{ij , ℓ}^{ℛ} = log \{ 1 + exp [ - {s}_{ij , ℓ} ] \} . \qquad ( 7 )$$

This loss can be applied to every binary CDF label [symbol] , for every example set, for every pair i, j of N(N−1)/2 pairs of examples in the set.

To enhance ranking loss on the true labels, but still reduce the chances a ranking loss can generate negative probabilities by unbalancing the points of the predicted CDF, a training system can apply the loss in equation (7) only when the true L-ary labels yᵢ and yⱼ of items i and j are unequal. The ranking loss for items i and j then becomes

$${L}_{ij}^{ℛ} = I ( {y}_{i} \neq {y}_{j} ) {\sum }_{ℓ = 0}^{L - 2} log \{ 1 + exp [ - {s}_{ij , ℓ} ] \} . \qquad ( 8 )$$

Example Approaches for Listwise Ranking with Ordinal Regression

A pairwise ranking loss can be computationally expensive, especially if the number of items N in an example set is large. The loss requires O(L N\hat{ }2) computations, linear in L for each of the label CDFs, and quadratic in N for each pair included in the loss (especially, if the loss in (7) is used). A single listwise loss for each label can reduce this complexity to O(LN). For a listwise loss that addresses relations between items with unequal labels, some example implementations can adopt equations (6) and (7), but apply the equations to all items and to the L−1 CDF losses instead of a single binary loss. Generalizing equation (6), define the aggregate score [symbol] for the [symbol] -th loss as

$${S}_{ℓ} {=}^{Δ} {\sum }_{i = 1}^{N} {z}_{i ℓ} \cdot {s}_{i ℓ} \qquad ( 9 )$$

Then, the listwise ranking (or relational) loss for the [symbol] -th label is given by

$${L}_{ℓ}^{ℛ} = I [ ∃ i > 1 : {z}_{i ℓ} \neq {z}_{1 ℓ} ] \cdot log ( 1 + {e}^{- {S}_{ℓ}} ) . \qquad ( 10 )$$

where I(.) is the indicator function, which in this case only indicates that the loss is applied only if not all labels of the [symbol] -th loss are equal. Then, the loss is the negative logarithm of the Sigmoid of the logit score [symbol] for each [symbol] .

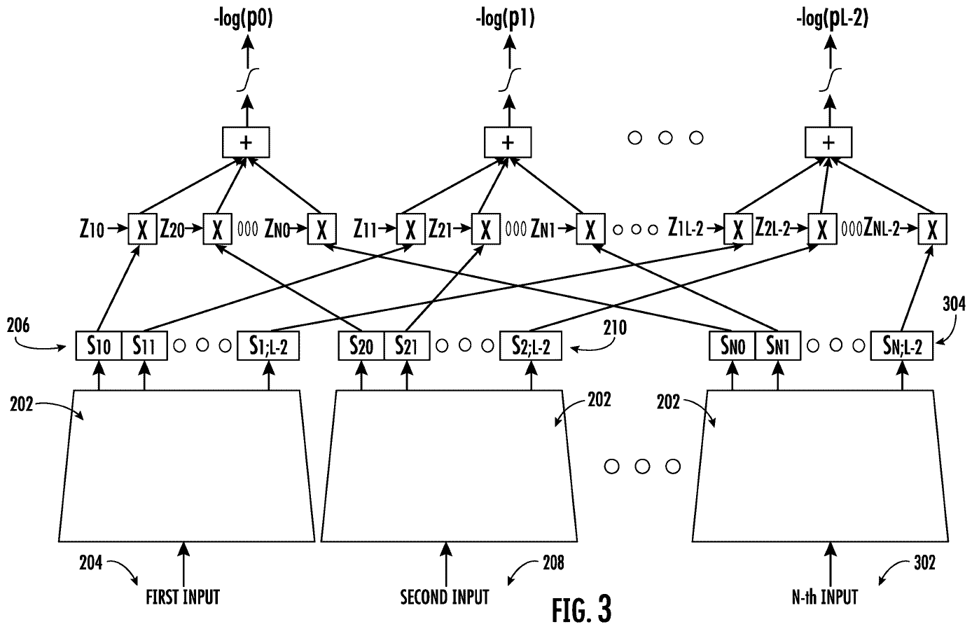

FIG. 3 depicts a graphical diagram of an example listwise loss of this nature. Specifically, FIG. 3 shows listwise ranking losses for CDF defined ordinal regression per CDF point. As illustrated in FIG. 3, the machine-learned ranking model 202 can be applied to the first input 204 and the second input 208 to generate the first score vector 206 and the second score vector 210 as described with reference to FIG. 2. The machine-learned ranking model 202 can also be applied to any number of additional inputs or items within the set of examples. For example, FIG. 3 shows the machine-learned ranking model 202 applied to an N-th input 302 to generate an N-th score vector 304. Then, the score vectors (e.g., 206, 210, 304) can be combined using the respective mapping vectors (e.g.,

$$( e . g . , {z}_{i}^{l} , {z}_{j}^{l} , {z}_{N}^{l} )$$

to generate a combined score vector according to the expression in equation (9). Again, individual scoring functions (e.g., logistic functions) can be used to obtain a respective output for each label. A loss (e.g., according to equation (10)) can be evaluated on the outputs and used to update the model 202.

As with the pairwise loss, the listwise loss will lead to gradients that push the CDF in the correct direction, such that the prediction of the label observed for any item i will increase, and predictions of labels not observed for i may decrease, depending on the collection of labels observed for all items. If label [symbol] is observed for item i, then [symbol] =1 and [symbol] [symbol] ₋₁=−1. The loss in (10) will result in positive updates for sᵢ [symbol] and negative for [symbol] ₋₁, which will increase the probability predicted for label [symbol] for item i, unless [symbol] =1 or [symbol] ₋₁=−1 for all j∈{1, . . . , N}. If both happen, then the labels yₖ of all N items are equal, and no ranking update will be necessary. If only one of the two sets of z labels ( [symbol] or [symbol] −1) is equal, then the other will push the CDF in the correct direction, still increasing the probability of label [symbol] for item i. If not all [symbol] are equal, then [symbol] will increase with [symbol] ₋₁ staying the same, overall increasing the probability of label [symbol] . Otherwise, [symbol] ₋₁ will decrease with sᵢₗ not changing, still increasing the probability for item i taking label [symbol] .

As with the pairwise loss, equation (10) does not apply the loss if for all examples in the list for the particular [symbol] -th CDF value the labels [symbol] are equal. This may exacerbate potential predictions of negative probabilities. As in equation (8) the listwise loss can be modified to not be applied only if the L-ary original labels are equal. This modifies equation (10) to

$${L}^{ℛ} = I [ ∃ i > 1 : {y}_{i} \neq {y}_{1} ] \cdot {\sum }_{ℓ = 0}^{L - 2} log ( 1 + {e}^{- {S}_{ℓ}} ) . \qquad ( 11 )$$

Alternatively to the losses described in equations (9)-(11), a softmax loss or an extended version of the Softmax listwise loss can be used for each of the CDF label values. There may be some advantage to using Softmax losses if some items on the list already have strong logits in the correct directions, but others do not. Using Softmax losses may prevent dilution of the updates to items that are still not correctly ranked due to the correctly ranked items. Replacing the loss in (9)-(10) by the extended version of the Softmax loss gives

$${L}_{ℓ}^{ℛ} = I [ ∃ i > 1 : {z}_{i ℓ} \neq {z}_{1 ℓ} ] \cdot log [ 1 + {\sum }_{i = 1}^{N} {e}^{- {z}_{i ℓ} \cdot {S}_{i ℓ}} ] . \qquad ( 12 )$$

This loss can be modified in the same manners as discussed for the loss in (9)-(10), including a respective version of equation (11).

### Example Ranking Objects Based on Ordinal Prediction Approach

CDF ordinal regression produces predictions to the staircase values of a CDF of the discrete PMF over L labels. Optimizing a ranking objective is proportional to maximizing the probability that objects are correctly ranked. Instead of using the mean label prediction, we can leverage the learned distribution to compute the probability that object A will have a better label than B and vice versa. We can, similarly, compute the probability that A has a better label than all other objects in a list. Then, objects are ranked by placing the objects with the greatest probability of having a better label than others first. This can be done pairwise or listwise, as described below. Additionally, if ranking is based on the predicted probability scaled by some other score multiplier (such as bids in an auction system), we can map the distribution to the post scaling score, and repeat similar computations relative to the scaled metric, where now the support (label set) of objects A and B may be different due to different scaling, but similar computations relative to the new scaled labels can be performed.

### Pairwise Ranking

We can rank by comparing pairs as follows. The objects in the pair are ranked by ranking the object with the higher probability of having a better label higher. The probability that object A has better label than B is given by

$$Pr ( {\hat{y}}_{A} > {\hat{y}}_{B} ) = {\sum }_{k = 0}^{L - 2} Pr ( {\hat{y}}_{B} = k ) \cdot Pr ( {\hat{y}}_{A} > k ) = {\sum }_{k = 0}^{L - 2} \{ Pr ( {\hat{y}}_{B} \leq k ) - Pr ( {\hat{y}}_{B} \leq k - 1 ) \} \cdot \{ 1 - Pr ( {\hat{y}}_{A} \leq k ) \} \qquad ( 13 )$$

Where Pr(ŷ_{B}≤−1)=0. The expression on the right can be computed directly from the CDF ordinal predictions. The same probability can also be computed by summing over the probabilities that A takes values k from 1 to L. If the predictions of A and B are scaled differently by multipliers, equation (13) can be adjusted by matching the respective CDF points of A and B.

Equation (13) can be used to compute Pr(ŷ_{A}>ŷ_{B}) and Pr(ŷ_{B}>ŷ_{A}). If Pr(ŷ_{A}>ŷ_{B})>Pr(ŷ_{B}>ŷ_{A}), then A is ranked higher. If the opposite is true, then B is ranked higher. If there is a tie, they are equally ranked.

This approach can technically produce cycles, where A is better than B which is better than C which is better than A. Probability differences can be used to break such cycles, by allocating a score of differences of object A relative to all other objects, and ranking by the cumulative difference against all other objects. Alternatively, however, a listwise approach can be applied as described below.

### Listwise Ranking

Assuming statistical independence, we can perform a similar computation to equation (13) to compute the probability that object A takes the maximal label of all objects in a list. This can be done according to the following:

$$\begin{matrix}Pr ( {\hat{Y}}_{A} is max ) = {\sum }_{k = 1}^{L - 1} Pr ( {\hat{y}}_{A} = k ) \cdot {\prod }_{B \neq A} Pr ( {\hat{y}}_{B} \leq k - 1 ) \\ = {\sum }_{k = 1}^{L - 1} \{ Pr ( {\hat{y}}_{A} \leq k ) - Pr ( {\hat{y}}_{A} \leq k - 1 ) \} \cdot {\prod }_{B \neq A} Pr ( {\hat{y}}_{B} \leq k - 1 )\end{matrix} \qquad ( 14 )$$

If multipliers scale objects differently before ranking, equation (14) can be adjusted by using the proper ordinals for all B objects that guarantee a scaled label not greater than k.

The object to be ranked first is the one that attains the maximum expression for the expression in equation (14). Suppose this object is A*. Because A* was included in the running product of object B for all objects before A* was selected, in order to rank the next object, the expressions for A* must be taken out of equation (14), and the computation must be repeated without A*, to select the second ranked object. This may be beneficial because ranking among runner ups may change. This process can continue until all objects are ranked. This requires O(N\hat{ }3 L) computations, where N is the number of objects in the list (N for ranking each of the N objects, times N for computing (14) for each object, times N×L for computing the expression in (14) for one object).

The computation process in (14) can be simplified to O(N\hat{ }2 L) operations, which is usually reasonable for practical problems as follows:

For every k∈{1, . . . , L−1}, compute Sₖ=Π_{B} Pr(y_{B}≤k−1) on all N objects (O(NL)).

For every object A and every k compute (avoiding division by 0):

$${S}_{kA} = {S}_{k} * \frac{Pr ( {y}_{A} \leq k ) - Pr ( {y}_{A} \leq k - 1 )}{Pr ( {y}_{A} \leq k - 1 )} = {S}_{k} * ( \frac{Pr ( {y}_{A} \leq k )}{Pr ( {y}_{A} \leq k - 1 )} - 1 )$$

(This requires O(NL) operations).

Compute the sum in (14) for every remaining object A:

$$Pr ( {\hat{y}}_{A} is max ) = {\sum }_{k = 1}^{L - 1} {S}_{kA} .$$

(This requires O(NL) operations, L for the sum times N for N sums).

Rank the object A* for which (14) is maximal from the remaining objects as the next object in the ranked list. Take it out of the set. For all k, update Sₖ, by dividing it by Pr(y_{A*}≤k−1) (O(L) operations). S_{kA} for all remaining A and for all k, can also be updated the same way (O(NL) operations), or the update can be done directly from Sₖ in the equation above. Repeat the previous step and this step with the new set of one less object.

The method described above can be repeated O(N) times for ranking all objects in the list at a total of O(N\hat{ }2 L) operations. If labels are scaled by multipliers, the updates of Sₖ and S_{kA} can be adjusted accordingly to reflect the correct ranking.

### Example Distillation Approaches

Distillation has become very popular in deep learning. In an example approach, to save on training resources, and comply with system constraints, a (relatively more) simple student model is trained (based on a relatively more complex teacher) and deployed. The student model avoids complexity and is restricted by deployment and system limitations. To speed training and also due to other system limitations, it can also train on fewer training examples. To close the accuracy gap, a rich teacher model, which is not limited by deployment constraints of the student model, is trained (possibly once for multiple students) on a much larger training dataset, and its predictions are used to train the student model, allowing for faster training and model convergence for the student. The student can train on both the teacher's predictions (or scores) and the true labels, or only on the former, depending on system constraints and other considerations.

Similarly to binary logistic regression models, distillation can be applied with ordinal regression directly for the regression loss, and/or for ranking. In both cases, distillation can be applied similarly to the binary case, with the exception that there are L−1 parallel distillations, one for each label CDF learned. Ranking distillation can be applied on pairwise differences, where for the [symbol] -th loss (where [symbol] ∈{0, 1, . . . , L−2}) the teacher score difference [symbol] − [symbol] is distilled into the student score difference [symbol] − [symbol] either for every pair in a set of items, or only for pairs for which the [symbol] -th labels [symbol] and [symbol] are different. Distillation can use any loss as cross entropy, L2 square loss, or L1, quantile regression, or Huber loss, or any other loss. Distillation can be applied directly on score differences, or on the Sigmoid of those differences, or on CDF differences. When distilling for ranking, the teacher should first train with the same loss, either pairwise or listwise.

If listwise ranking loss is used, distillation with any of these losses can be applied on the aggregate score [symbol] for each of the L−1 losses for the losses in equations (9)-(11). This requires use of the true labels to determine the aggregate scores. This means that a single score per label CDF is distilled for an example set (or a query). The scores themselves can be distilled, or their Sigmoid transformation. As with the pairwise case, distillation can be applied for all queries for all CDF values, or only for queries that have unequal labels for a specific CDF label. Specifically, if distillation is only applied for sets where items take more than a single label, then whether to distill for some CDF label is determined per CDF label. If for label [symbol] all N labels [symbol] are equal, then no distillation occurs for the [symbol] -th loss. However, it does not preclude distillation from occurring for the k-th loss, for the k-th set of labels, if there exist different values of [symbol] . Excluding distillation for CDF losses for example sets where all labels are equal may encourage the loss to focus on label differences.

Distillation can also be applied with Softmax listwise ranking loss, where for each ordinal CDF label, separate binary softmax listwise distillation loss is applied. This is also true for extensions of the Softmax listwise ranking loss.

### Example Approaches for Ranking Across Queries

Ranking loss for ordinal regression was described in this document as a loss that is applied for pairs or lists of items that appear or are co-recommended in the same set of items, where there are multiple such sets of items in the training data. In a recommendation system, these sets can be items that are shown to a user in response to a single query. In some systems, for example, when items are rated by human evaluators, it may be desirable to apply ranking on pairs or lists of items outside the set or query boundaries. This is done when we want to calibrate the rating among items and achieve a better ranking of labels associated with the items, and we care less about interactions between items in the same set. Both the pairwise and listwise losses proposed in this document can be applied to this setting because they are defined between a pair or for a list of items, and mathematically, there is no requirement for the items to be in the same set or recommendation set.

### Example Devices and Systems

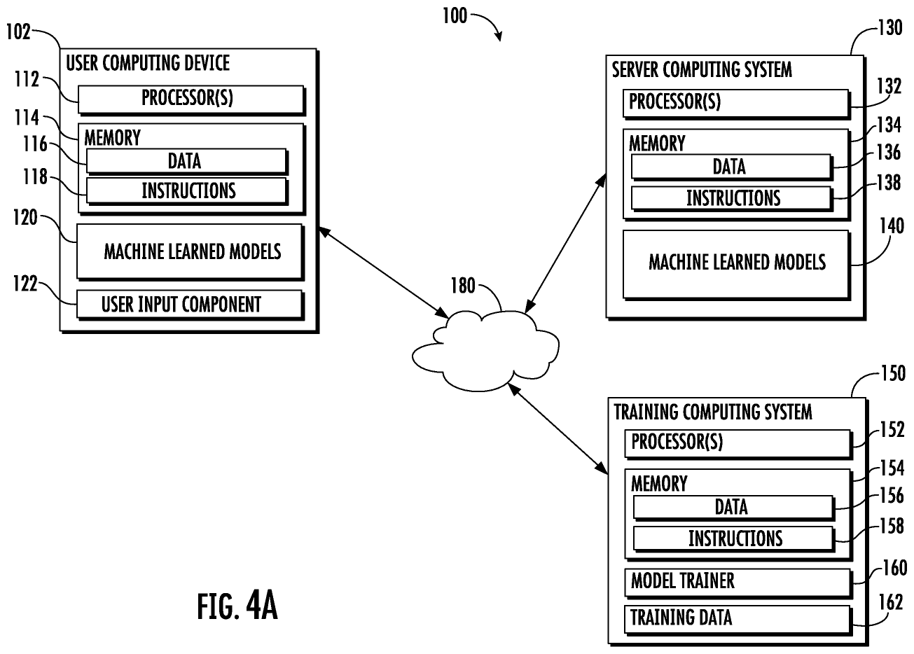

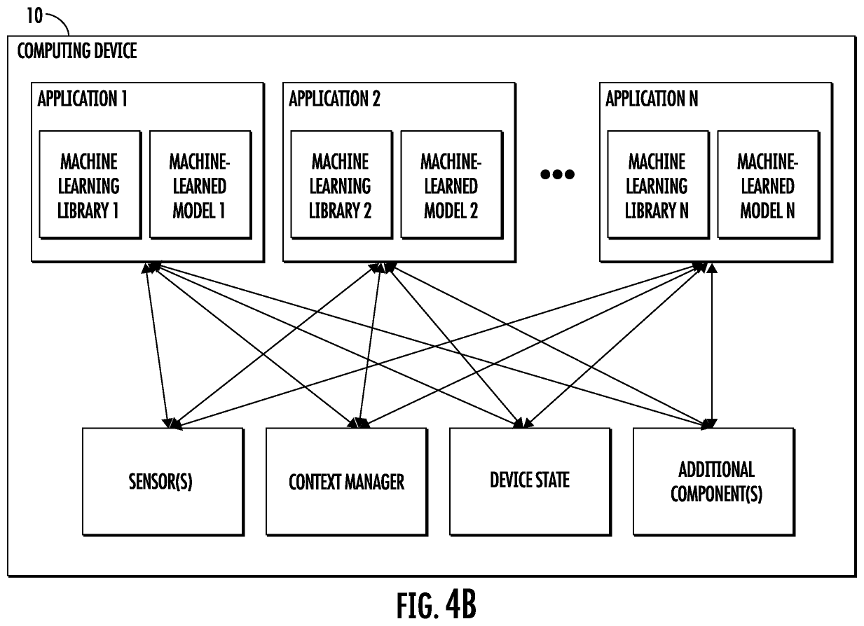

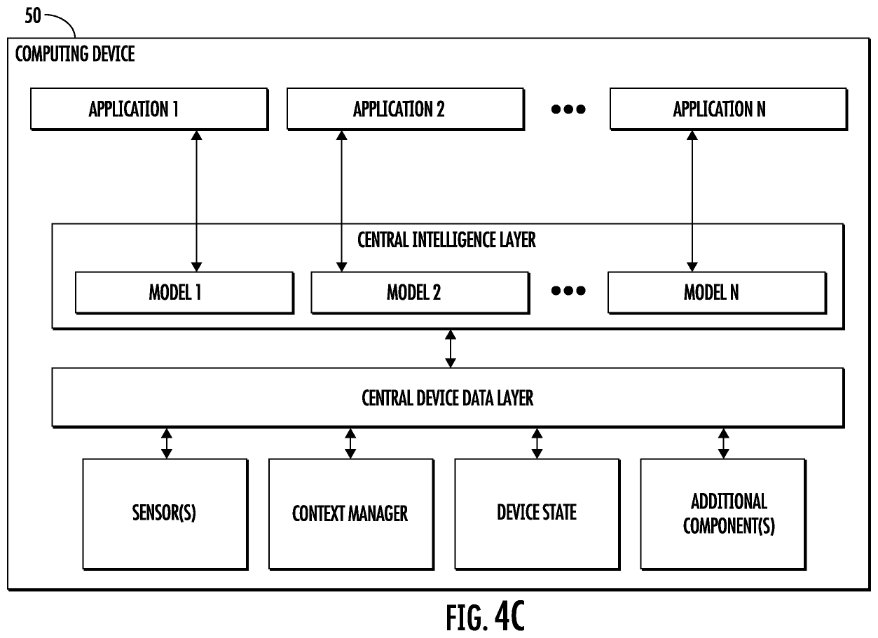

FIG. 4A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned ranking models 120. For example, the machine-learned ranking models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned ranking models 120 can be received from the server computing system 130 over network 180, stored in the user computing device memory 114, and then used or otherwise implemented by the one or more processors 112. In some implementations, the user computing device 102 can implement multiple parallel instances of a single machine-learned ranking model 120 (e.g., to perform parallel ranking across multiple instances of pairwise inputs).

Additionally or alternatively, one or more machine-learned ranking models 140 can be included in or otherwise stored and implemented by the server computing system 130 that communicates with the user computing device 102 according to a client-server relationship. For example, the machine-learned ranking models 140 can be implemented by the server computing system 140 as a portion of a web service (e.g., a information retrieval service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned ranking models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned ranking models 120 and/or 140 based on a set of training data 162. The training data 162 can include, for example, inputs annotated with ground truth labels.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method to perform training for ranking with ordinal regression on graded multi-valued labeled data, the method comprising:
processing, by a computing system comprising one or more computing devices, a first input with a machine-learned ranking model to generate a first score vector for the first input;
processing, by the computing system, a second input with the machine-learned ranking model to generate a second score vector for the second input;
determining, by the computing system, a combined score vector for the first input and the second input based on the first score vector and the second score vector, the combined score vector having a plurality of coordinates;
applying, by the computing system, a respective scoring function to each of the plurality of coordinates of the combined score vector to generate a respective label output for each of a plurality of labels; and
evaluating, by the computing system, a ranking loss function based on one or more of the respective label outputs generated for the plurality of labels; and
modifying, by the computing system, the machine-learned ranking model based on the ranking loss function.

2. The computer-implemented method of claim 1, wherein the plurality of labels comprise Cumulative Distribution Function (CDF) labels.

3. The computer-implemented method of claim 1, wherein the label output for each label indicates a respective predicted probability that the first input has a first ground truth multi-valued label value that is greater than the label while the second input has a second ground truth multi-valued label value that is less than or equal to the label.

4. The computer-implemented method of claim 1, wherein the ranking loss function is applied only to labels of the plurality of labels for which a respective first Cumulative Distribution Function (CDF) label value for the first input is unequal to a respective second CDF label value for the second input.

5. The computer-implemented method of claim 4, wherein, for each label of the plurality of labels, the ranking loss comprises a negative logarithm of a conditional probability that a second ground truth label value of the second input is smaller than or equal to the label while a first ground truth label value of the first input is larger than the label, conditioned on the event that one of the first ground truth label value or the second ground truth label value is larger than the label and the other of the first ground truth label value or the second ground truth label value is smaller than the label.

6. The computer-implemented method of claim 1, wherein the combined score vector comprises a difference vector between the first score vector and the second score vector.

7. The computer-implemented method of claim 1, wherein the combined score vector comprises a signed label-weighted sum of the first score vector and the second score vector.

8. The computer-implemented method of claim 7, wherein each respective scoring function comprises a logistic function.

9. The computer-implemented method of claim 8, wherein the ranking loss function is applied only when a first multi-valued ground truth label value for the first input is unequal to a second multi-valued ground truth label value for the second input.

10. The computer-implemented method of claim 2, wherein the ranking loss comprises a pairwise loss for the first input and the second input.

11. The computer-implemented method of claim 1, wherein the ranking loss comprises a listwise loss for the first input, the second input, and at least a third input with multi-valued labels.

12. The computer-implemented method of claim 1, wherein the predicted CDFs are used to rank items with pairwise ranking, selecting the items that have the largest probability of having a better label to be ranked first.

13. The computer-implemented method of claim 1, wherein the predicted CDFs are used to produce a predicted probability that any item has better label than all other items, and using such probability for ranking all items in a list.

14. The computer-implemented method of claim 11, further comprising:
processing, by the computing system, the third input with the machine-learned ranking model to generate a third score vector for the third input;
wherein the combined score vector is further based on the third score vector.

15. The computer-implemented method of claim 14, wherein the combined score vector comprises a sum, for all inputs in a set of inputs, of the respective score vector for the input times a respective mapping vector for the input, wherein the respective mapping vector for the input maps respective Cumulative Distribution Function (CDF) label values for the input to one or negative one.

16. The computer-implemented method of claim 1, further comprising:
evaluating, by the computing system, a distillation loss function, wherein the distillation loss function compares:
the combined score vector and a teacher score vector generated for the first input and the second input by a teacher model;
combined score difference vectors between two scores or cumulative scores for lists of items and such combined scores by the teacher;
sigmoid values generated from the combined score vector and the teacher score vector; or
CDF values generated from the combined score vector and the teacher score vector; and
modifying, by the computing system, the machine-learned ranking model based on the distillation loss function.

17. The computer-implemented method of claim 16, wherein the first input and the second input comprise responses to a shared query.

18. A computer system configured to perform operations, the operations comprising:
processing, by the computing system, a first input with a machine-learned ranking model to generate a first score vector for the first input;
processing, by the computing system, a second input with the machine-learned ranking model to generate a second score vector for the second input;
determining, by the computing system, a combined score vector for the first input and the second input based on the first score vector and the second score vector, the combined score vector having a plurality of coordinates;
applying, by the computing system, a respective scoring function to each of the plurality of coordinates of the combined score vector to generate a respective label output for each of a plurality of labels;
evaluating, by the computing system, a ranking loss function based on one or more of the respective label outputs generated for the plurality of labels; and
modifying, by the computing system, the machine-learned ranking model based on the ranking loss function.

19. (canceled)

20. One or more non-transitory computer-readable media that store a machine-learned ranking model that has been trained by performance of training operations, the training operations comprising:
processing, by a computing system, a first input with a machine-learned ranking model to generate a first score vector for the first input;
processing, by the computing system, a second input with the machine-learned ranking model to generate a second score vector for the second input;
determining, by the computing system, a combined score vector for the first input and the second input based on the first score vector and the second score vector, the combined score vector having a plurality of coordinates;
applying, by the computing system, a respective scoring function to each of the plurality of coordinates of the combined score vector to generate a respective label output for each of a plurality of labels;
evaluating, by the computing system, a ranking loss function based on one or more of the respective label outputs generated for the plurality of labels; and
modifying, by the computing system, the machine-learned ranking model based on the ranking loss function.
